(19) United States
(12) Patent Application Publication
(10) Pub. No.: US 2026/0129532 A1
(43) Pub. Date: May 7, 2026

(54) METHODS, ARCHITECTURES, APPARATUSES AND SYSTEMS FOR ASYNCHRONOUS REPORTING OF CHANNEL STATE INFORMATION

(71) Applicant: InterDigital Patent Holdings, Inc., Wilmington, DE (US)

(72) Inventors: Paul Marinier, Brossard (CA); Ghyslain Pelletier, Montréal (CA); Samuli Turtinen, Ii (FI); Moon IL Lee, Melville, NY (US)

(21) Appl. No.: 18/936,475

(22) Filed: Nov. 4, 2024

(51) Int. Cl. H04W 36/08; H04W 36/00

(52) U.S. Cl. CPC H04W 36/08; H04W 36/0058; H04W 36/0072

(57) ABSTRACT

A wireless transmit/receive unit (WTRU) may initiate, for each cell of a set of candidate cells, one or more channel state information (CSI) measurements using a set of resources associated with the respective cell. The WTRU may initiate a cell switch, or handover, to a target cell. The WTRU may transmit, based on the target cell being a candidate cell of the set and using a first available uplink resource in the target cell, information indicating the one or more CSI measurements were initiated for the target cell. The WTRU may, after completion of the one or more CSI measurements which were initiated for the target cell, transmit, using a second available uplink resource, information indicating that measurement information associated with the one or more CSI measurements for the target cell is available based on the second available uplink resource having an insufficient payload to carry the measurement information.

### BACKGROUND

The present application is related to the fields of communications, software and encoding, including, for example, to methods, architectures, apparatuses, systems directed to asynchronous reporting of channel state information (CSI).

3GPP 5G New Radio (NR) specifies different mechanisms for the measurement and reporting of CSI. In periodic CSI reporting, for example, a wireless transmit/receive unit (WTRU) reports on resources that recur periodically. In semi-persistent CSI reporting, a WTRU starts reporting on resources that recur periodically after reception of an activation command. In aperiodic CSI reporting, a WTRU reports once on a resource indicated by downlink control information (DCI). A WTRU needs a minimum amount of time to compute the CSI, such as after receiving a DCI indicating a CSI request.

A first issue is that uplink scheduling is generally slowed down when the network requests aperiodic CSI. A second issue is that it takes time for the network to obtain detailed CSI information after handover (or cell switch) since the request is performed only after the WTRU has connected to the target cell.

There is a need to provide procedures which support a WTRU to determine when to report a set of CSI results and/or which (sub)set of CSI results to include in a report.

### BRIEF SUMMARY

Briefly stated, in one embodiment, a WTRU may execute a cell switch on a target cell and indicate if CSI results are or will be available for this target cell based on whether the WTRU had initiated CSI measurements associated with the target cell before the cell switch.

In one embodiment, a WTRU may initiate, for each candidate cell of a set of candidate cells, one or more CSI measurements using a set of resources associated with the respective candidate cell. The WTRU may initiate a cell switch (or handover) to a target cell. The WTRU may transmit, based on the target cell being a candidate cell of the set of candidate cells and using a first available uplink resource in the target cell, information indicating the one or more CSI measurements were initiated for the target cell. The WTRU may, after completion of the one or more CSI measurements which were initiated for the target cell, transmit, using a second available uplink resource, information indicating that measurement information associated with the one or more CSI measurements for the target cell is available based on the second available uplink resource having an insufficient payload to carry the measurement information.

In one embodiment, a WTRU may initiate, for each candidate cell of a set of candidate cells, one or more CSI measurements using a set of resources associated with the respective candidate cell. The WTRU may initiate a cell switch to a target cell. The WTRU may transmit, based on (e.g., determining that) the target cell being (e.g., is) a candidate cell of the set of candidate cells and using a first available uplink resource in the target cell, information indicating the one or more CSI measurements were initiated for the target cell. After completion of the one or more CSI measurements which were initiated for the target cell, the WTRU may transmit, using a second available uplink resource, information indicating that measurement information associated with the one or more CSI measurements for the target cell is available based on the second available uplink resource having an insufficient payload to carry the measurement information.

In one embodiment, a WTRU may initiate, for each candidate cell of a set of candidate cells, one or more CSI measurements using a set of resources associated with the respective candidate cell. The WTRU may initiate a cell switch to a target cell. The WTRU may transmit, based on (e.g., determining that) the target cell being (e.g., is) a candidate cell of the set of candidate cells and using a first available uplink resource in the target cell, information indicating the one or more CSI measurements were initiated for the target cell. After completion of the one or more CSI measurements which were initiated for the target cell, the WTRU may transmit, using a second available uplink resource, information indicating measurement information associated with the one or more CSI measurements for the target cell based on the second available uplink resource having a sufficient payload to carry the measurement information.

In one embodiment, a WTRU may initiate, for a set of candidate cells, CSI measurements using resource occasions associated with the candidate cells. The WTRU may initiate a cell switch or a handover to a target cell. The WTRU may transmit, using a first uplink resource in the target cell, information indicating one or more of the CSI measurements were initiated for the target cell based on the target cell being one of the candidate cells. The WTRU may, after completion of the one or more of the CSI measurements which were initiated for the target cell, transmit, using a second uplink resource, information indicating that CSI report information associated with the one or more of the CSI measurements for the target cell is available. For example, the WTRU may perform the transmission using the second uplink resource when it is determined that any available uplink resource is insufficient to carry the CSI report information.

In one embodiment, a WTRU may initiate, for a set of candidate cells, CSI measurements using resource occasions associated with the candidate cells. The WTRU may initiate a cell switch or a handover to a target cell. The WTRU may transmit, using a first uplink resource in the target cell, information indicating one or more of the CSI measurements were initiated for the target cell based on the target cell being one of the candidate cells. The WTRU may, after completion of the one or more of the CSI measurements which were initiated for the target cell, transmit, using a second uplink resource, CSI report information associated with the one or more of the CSI measurements for the target cell. For example, the WTRU may perform the transmission using the second uplink resource when it is determined that the second uplink resource is sufficient to carry the CSI report information.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example communications system, according to one or more embodiments of the present disclosure;

FIG. 1B is a system diagram illustrating an example wireless transmit/receive unit (WTRU) that may be used within the communications system illustrated in FIG. 1A, according to one or more embodiments of the present disclosure;

FIG. 1C is a system diagram illustrating an example radio access network (RAN) and an example core network (CN) that may be used within the communications system illustrated in FIG. 1A, according to one or more embodiments of the present disclosure;

FIG. 1D is a system diagram illustrating a further example RAN and a further example CN that may be used within the communications system illustrated in FIG. 1A, according to one or more embodiments of the present disclosure;

FIG. 2 is a flowchart diagram illustrating an example flow for asynchronous reporting of CSI, according to one or more embodiments of the present disclosure;

FIG. 3 is a procedural diagram illustrating an example procedure to indicate that CSI measurements are available for a target cell, according to one or more embodiments of the present disclosure;

FIG. 4 is a procedural diagram illustrating an example procedure to transmit CSI measurements available for a target cell, according to one or more embodiments of the present disclosure;

FIG. 5 is a procedural diagram illustrating an example procedure to indicate that CSI reporting information is available for a target cell, according to one or more embodiments of the present disclosure; and

FIG. 6 is a procedural diagram illustrating an example procedure to transmit CSI reporting information available for a target cell, according to one or more embodiments of the present disclosure.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

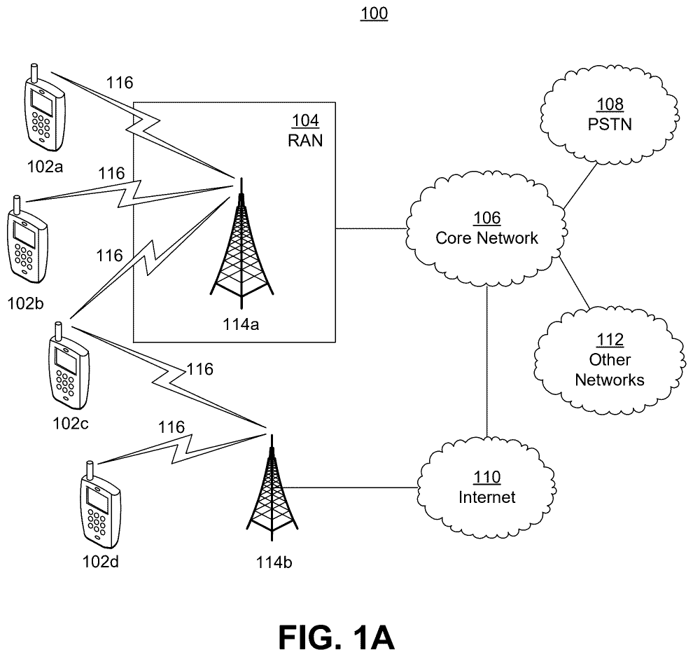

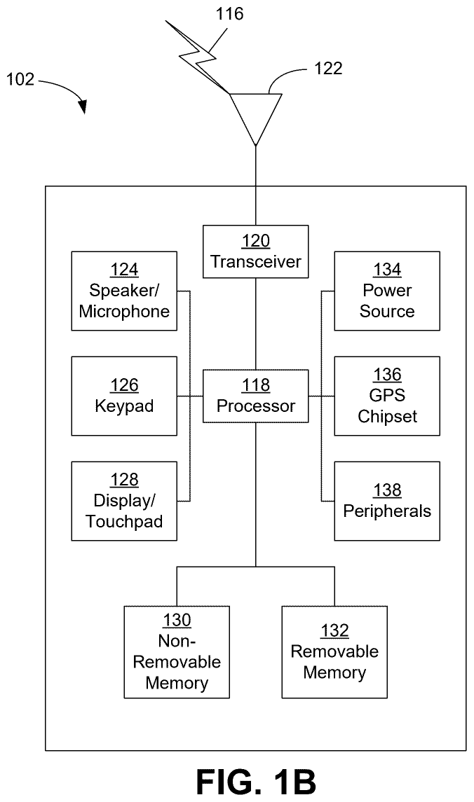

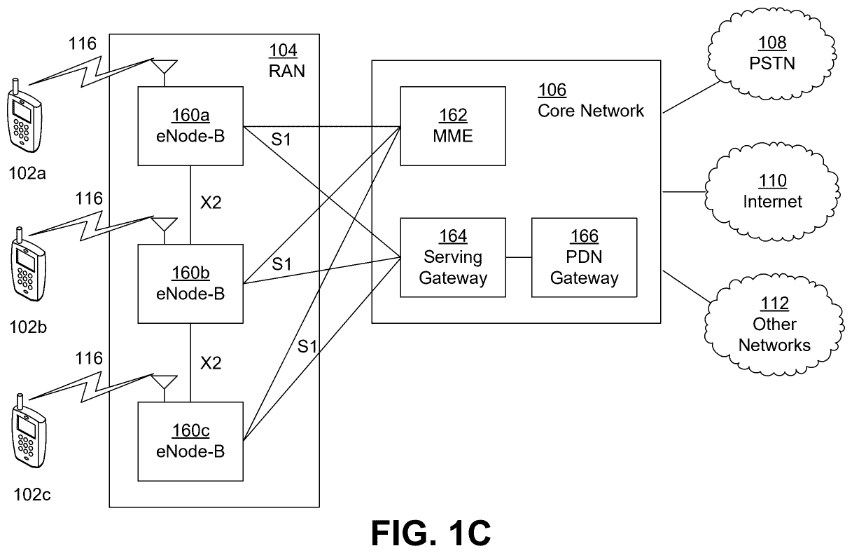

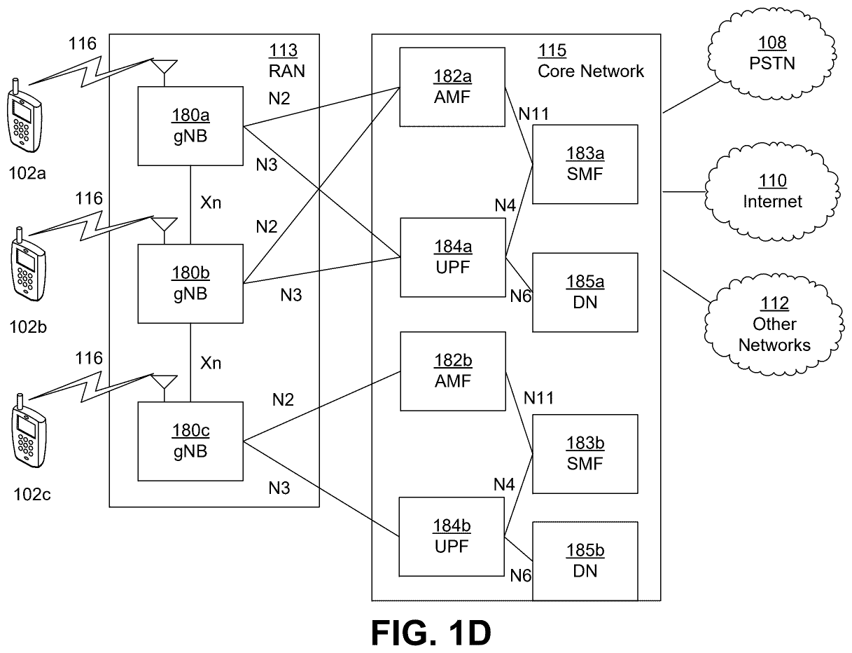

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

Wireless communication systems, such as 5G NR systems, support WTRU 102 CSI measurement and reporting, such for the purposes of link adaptation. In NR Release 18, CSI may include (e.g., refer to) any of channel quality indicator (CQI), precoding matrix indicator (PMI), CSI-RS resource indicator (CRI), SS/PBCH block resource indicator (SSBRI), layer indicator (LI), rank indicator (RI), L1-RSRP, L1-SINR, or time-domain channel properties (TDCP).

The CSI functionality may involve a WTRU 102 performing measurements on one or more resources for the purpose of estimating channel and interference. The WTRU 102 may then report various types of information. 3GPP NR specifies different mechanisms for the measurement and reporting of CSI, such as periodic, semi-persistent, and aperiodic CSI reporting. A benefit of aperiodic CSI reporting is that it allows the WTRU 102 report more detailed and extensive CSI information without causing excessive reporting overhead, since the reporting occurs once and on-demand.

A WTRU 102 needs a minimum amount of time to compute CSI, such as after receiving downlink control information (DCI) indicating a CSI request. The CSI computation time can be significant and may result in the following issues.

A first issue is that uplink scheduling is generally slowed down when the network requests aperiodic CSI. This is because the CSI computation time may typically be longer than the processing time for the preparation of a physical uplink shared channel (PUSCH) transmission containing higher-layer data (e.g., without CSI). The network thus needs to indicate a PUSCH resource that occurs at (e.g., long) time in the future from when aperiodic CSI is requested. Since out-of-order PUSCH scheduling is not supported, issuing grants without a CSI request immediately after cannot improve the situation.

A second issue is that it takes time for the network to obtain detailed CSI information after a handover (or cell switch) since the request is performed only after the WTRU 102 has connected to a target cell. This results in poor downlink throughput for a significant duration after the handover. To overcome this limitation, it has been proposed that NR supports that the WTRU 102 can measure CSI of a target cell before executing a cell switch and report the CSI before or after the cell switch.

To overcome the issues caused by CSI computation time, solutions are described herein to enable decoupling of the triggering between the initiation of CSI measurement(s) and computation, and the transmission of a corresponding CSI report. Such decoupled triggering may remove the limitation associated with uplink scheduling when aperiodic CSI is requested and may allow faster reporting of CSI following a handover or cell switch.

To enable decoupled CSI reporting, solutions are needed for the WTRU 102 to determine when to report a set of CSI results and/or which (sub)set CSI results to include in a report.

### Overview

### Framework for Decoupling CSI Reporting Trigger

As used herein, the term “CSI instance” may be used to refer to a set of CSI information that may be computed for a given CSI reference resource (e.g., in the time and frequency domains). For example, the results of the CSI instance may be reported in a single PUSCH or physical uplink control channel (PUCCH) transmission.

As used herein, the term “measurement trigger” may be used to refer to a trigger condition. For example, a WTRU 102 may first initiate measurements and computation for at least one CSI instance (e.g., according to a CSI reporting configuration and/or trigger state describing resources for channel and interference measurements, CSI quantities to report, antenna ports configuration, frequency granularity, how the results are reported, and the like). The CSI measurement and/or computation may be initiated when a (e.g., first) trigger condition occurs.

As used herein, the term “configured CSI” may be used to refer to a CSI report configuration and, if applicable, a trigger state associated with the CSI report configuration.

As used herein, the term “minimum duration” may be defined or configured between a CSI reference resource for which a CSI instance is calculated and a time when the WTRU 102 reports valid results for the corresponding CSI instance. For example, a minimum duration may depend on the number of processing units used for CSI calculation, CSI configuration aspects including at least one of CSI quantity, CSI measurement resources, codebook type, and the like.

As used herein, the term “CSI instance prioritization” may refer to where a WTRU 102 may compute more than one CSI instance in parallel. The WTRU 102 may have a maximum capability for the number of processing units available for calculation of CSI(s). For example, a WTRU 102 may deprioritize computation of certain CSI instances if the maximum capability would be exceeded, according to specified priority rules and/or explicit priority indication. For example, a WTRU 102 may cancel or delay computation of a deprioritized CSI instance.

As used herein, the term “reporting trigger’ may be used to refer to a trigger condition. For example, a WTRU 102 may initiate reporting of results for at least one CSI instance when a (e.g., second) trigger condition occurs. Such trigger condition may by referred to as “reporting trigger”. In decoupled CSI reporting, the reporting trigger may be different from the measurement trigger for any given CSI instance.

As used herein, the term “reporting procedure” may refer to a procedure used to report CSI. For example, a WTRU 102 may follow a CSI reporting procedure to include at least one CSI result in a reporting resource. Such a procedure may define whether and/or how the WTRU 102 obtains resources for the reporting, the reporting format, reporting container (e.g., MAC control element or UCI) and the like.

As used herein, the term “CSI configuration identity” may refer to an identifier of a CSI configuration. For example, a CSI configuration may include a (e.g., first) CSI report configuration identity that may be specific to that configuration. A CSI configuration may further include a (e.g., second) identity that may not be specific (e.g., non-unique) to the CSI report configuration. The WTRU 102 may receive signaling initiating CSI calculation and/or CSI reporting that includes at least one identity. For example, the WTRU 102 may execute actions described below for the set of CSI configurations whose first or second identity match the at least one identity included in the signaling

### CSI Measurement Triggering

### Triggers for Initiating CSI Measurement and Computation

In certain representative embodiments, a WTRU 102 may use one or more triggers for initiating CSI measurement and/or CSI computation.

In certain representative embodiments, a WTRU 102 may initiate or activate CSI measurement and/or computation of at least one CSI instance when at least one trigger condition occurs (e.g., is satisfied). For example, a trigger condition for activating CSI measurement and/or CSI computation may include any one of, or a combination of, at least one of following events.

In some embodiments, a WTRU 102 may receive signaling indicating to activate CSI computation for at least one configured CSI. For example, a WTRU 102 may activate CSI computation for the at least one indicated configured CSI. As an example, an indication (e.g., of a configured CSI) may be received from a physical downlink control channel (PDCCH) transmission, such as via DCI or in a MAC CE. For example, a value of a field (e.g., of DCI) may indicate whether the signaling is for activating CSI computation. As an example, an indication (e.g., of a configured CSI) may be by an index, such as an index to an identity of a measurement resource (e.g., associated with the configured CSI) or to an identity of a candidate TCI state (e.g., associated with the configured CSI). As an example, an indication (e.g., of a configured CSI) may be by a trigger state, such as a field in the signaling (e.g., DCI) indicating the trigger state.

In some embodiments, a WTRU 102 may receive signaling triggering activation of CSI computation for candidate cells (e.g., in L1/2-triggered mobility (LTM)), such as signaling activating candidate cell TCI states. For example, a WTRU 102 may activate CSI computation for at least one configured CSI associated with an activated candidate cell TCI state. For example, a WTRU 102 may receive an indication, such as for each activated candidate cell TCI state, of whether or not to activate CSI computation of its associated configured CSI.

In some embodiments, a WTRU 102 may activate an associated candidate TCI state. For example, a WTRU 102 may receive configuration information of whether or not to activate CSI computation when an associated candidate cell TCI state is activated.

In some embodiments, a WTRU 102 may receive signaling indicating a handover or a LTM cell switch (e.g., from a serving cell to a target cell). For example, a WTRU 102 may activate CSI computation for at least one configured CSI associated with the indicated target cell or the indicated TCI state. As an example, a WTRU 102 may activate the CSI computation (e.g., only) if explicitly indicated in the signaling.

In some embodiments, a WTRU 102 may determine a condition triggering a handover or a LTM cell switch (e.g., to a target cell). For example, a WTRU 102 may activate CSI computation for at least one configured CSI associated with the target cell, or for at least one configured CSI associated to one or more measurement resources triggering the condition.

In some embodiments, a WTRU 102 may measure and/or report measurement results for L1 measurement resources satisfying at least one triggering condition for activating CSI computation of at least one associated CSI configuration. For example, a WTRU 102 may activate CSI computation for the configured CSI(s) associated with an L1 measurement resource for which a measurement result satisfies the condition. For example, a condition may be that a measurement quantity (e.g., L1-RSRP) for an associated L1 measurement resource is higher than a measurement quantity of a resource corresponding to the serving cell (e.g., plus an offset, which may be predefined or configured). For example, a condition may be that a measurement quantity for an associated L1 measurement resource is one of K highest measurement quantities among a set of L1 measurement resources (e.g., K may be predefined or configured). For example, a condition may be that the WTRU 102 implicitly activates an associated candidate TCI state when measuring and/or reporting the measurement results.

In some embodiments, a WTRU 102 may switch to (e.g., activate) a different bandwidth part (BWP) (e.g., from a first BWP to a second BWP). For example, a WTRU 102 may activate CSI computation for at least one configured CSI associated with the (e.g., active) BWP.

In some embodiments, a WTRU 102 may activate a serving cell and/or carrier. For example, a WTRU 102 may activate CSI computation for at least one configured CSI associated with the (e.g., activated) serving cell and/or carrier.

In some embodiments, a WTRU 102 may detect a signal, such as a low-power wake-up signal (LP-WUS). For example, a WTRU 102 may activate CSI computation for at least one configured CSI associated with the signal.

In some embodiments, a WTRU 102 may determine that data becomes available for transmission, such as for a particular logical channel and/or data flow.

In some embodiments, a WTRU 102 may receive data for a logical channel and/or data flow. For example, a WTRU 102 may activate CSI computation for at least one configured CSI associated with the logical channel and/or data flow for which data is available and/or for which the WTRU 102 received data.

In some embodiments, a WTRU 102 may receive an indication to perform a RACH transmission (e.g., as part of a 2-step or 4-step RACH procedure). For example, a WTRU 102 may activate CSI computation for at least one configured CSI associated with a PRACH resource, cell, and/or SSB index.

In some embodiments, a WTRU 102 may trigger a random access (RA) procedure. For example, a WTRU 102 may activate CSI computation for at least one configured CSI associated with an SSB index, such as an SSB index selected for the transmission of an associated PRACH resource. For example, a WTRU 102 may activate CSI computation for at least one configured CSI associated with a PRACH resource (e.g., to be transmitted).

In some embodiments, a WTRU 102 may move to a position within a (e.g., new) zone or geographic area. For example, a WTRU 102 may activate CSI computation for at least one configured CSI associated with a (e.g., current) zone. For example, a WTRU 102 may deactivate CSI computation for at least one configured CSI associated with a zone (e.g., of a previous position).

In some embodiments, a WTRU 102 may determine or receive an indication that a TCI state associated with a PDCCH, PDSCH, PUSCH and/or SRS (e.g., configuration) changes. For example, a WTRU 102 may activate CSI computation for at least one configured CSI associated with an indicated TCI state. For example, a WTRU 102 may deactivate CSI computation for at least one configured CSI associated with a (e.g., previously) indicated TCI state.

### Triggers for Stopping CSI Measurement and Computation

In certain representative embodiments, a WTRU 102 may use one or more triggers for stopping CSI measurement and/or CSI computation.

In certain representative embodiments, a WTRU 102 may stop and/or deactivate CSI measurement and/or computation of at least one CSI instance when a trigger condition occurs. A trigger condition for deactivating CSI computation may include any one of, or a combination of, at least one of following events.

In some embodiments, a WTRU 102 may receive signaling indicating to deactivate CSI computation for at least one configured CSI. For example, a WTRU 102 may deactivate CSI computation for the at least one indicated configured CSI. The indication may be received from a PDCCH transmission, such as via DCI or in a MAC CE.

In some embodiments, a WTRU 102 may receive signaling triggering the deactivation of CSI computation for one or more candidate cells (e.g., in LTM), such as signaling de-activating candidate cell TCI states. For example, a WTRU 102 may deactivate CSI computation for at least one configured CSI associated with a de-activated candidate cell TCI state.

In some embodiments, a WTRU 102 may receives signaling indicating a handover or a LTM cell switch. For example, a WTRU 102 may deactivate CSI computation for at least one configured CSI not associated with an indicated target cell and/or an indicated TCI state.

In some embodiments, a WTRU 102 may determine a condition triggering a handover or a LTM cell switch (e.g., to a target cell). For example, a WTRU 102 may deactivate CSI computation for at least one configured CSI not associated with a target cell, or for configured CSI not associated to one or more measurement resources associated with triggering the condition.

In some embodiments, a WTRU 102 may report measurement results for L1 measurement resources not satisfying a condition for initiating CSI computation of at least one associated CSI configuration. For example, a WTRU 102 may deactivate CSI computation for at least one configured CSI associated with a L1 measurement result not satisfying the condition.

In some embodiments, a WTRU 102 may switch to a (e.g., target) BWP (e.g., from another BWP). For example, a WTRU 102 may deactivate CSI computation for at least one configured CSI not associated with the target (e.g., active) BWP.

In some embodiments, a WTRU 102 may deactivate a serving cell and/or carrier. For example, a WTRU 102 may deactivate CSI computation for at least one configured CSI associated with the serving cell and/or carrier.

In some embodiments, a WTRU 102 may deactivate CSI computation of at least one configured CSI for which the WTRU 102 reported a maximum number (e.g., N) of CSI instances for which the WTRU 102 reported a maximum number (e.g., M) of times.

In some embodiments, a duration (e.g., time interval) since a last activity (e.g., related to at least one configured CSI) occurred may exceed a threshold. For example, the activity may include any of reception of a PDCCH and/or PDSCH transmission, and/or any of a PDCCH and/or PDSCH transmission scheduling or containing downlink data for a logical channel and/or data flow associated to the configured CSI. For example, the activity may include any of PUCCH and/or PUSCH transmission, a PUCCH transmission containing a scheduling request for a logical channel and/or data flow associated with the configured CSI, and/or a PUSCH transmission containing data for a logical channel and/or data flow associated with the configured CSI. For example, the activity may include triggering of a CSI reporting instance for the configured CSI. For example, the WTRU 102 may transmit an indication that CSI computation is deactivated (e.g., for at least one configured CSI).

In some embodiments, a WTRU 102 may receive signaling (e.g., via RRC or MAC) for determining any of an association, a number of CSI instances, and/or a number of CSI reports which may (de)activate or be used to (de)activate CSI computation. For example, the association may be between a (e.g., at least one) configured CSI and any of: at least one TCI state, at least one candidate TCI state, at least one measurement resource, at least one cell, at least one bandwidth part, a serving cell, at least one logical channel, at least one data flow, at least one PRACH resource, at least one SSB index, and/or at least one zone (e.g., geographic area).

For example., the WTRU 102 may receive (e.g., RRC or MAC) signaling for determining any of a maximum number of CSI instances (e.g., N) and/or reports (e.g., M) for (e.g., each of) at least one configured CSI.

### CSI Reference Resource Occasions

In certain representative embodiments, a WTRU 102 may determine a set of (e.g., possible) CSI reference resources in the time domain upon activating CSI computation. An (e.g., each) element of the set may be referred to as a “CSI reference resource occasion”. The WTRU 102 may compute results of a CSI instance for each (e.g., possible) CSI reference resource occasion. The WTRU 102 may (e.g., only) report a CSI instance for a CSI reference resource occasion if it satisfies one or more conditions, such as may be determined by (e.g., using) a CSI reporting trigger.

In certain representative embodiments, a set of CSI reference resource occasions may include one of following sets of valid downlink slots or downlink symbols: any valid downlink slot or downlink symbol; a set of valid downlink slots or downlink symbols identified by a period and offset; a set of valid downlink slots or downlink symbols identified by a bitmap (e.g., that may be repeating in time).

In certain representative embodiments, a set of CSI reference resource occasions may be identified by at least one of a period, an offset, a bitmap, and/or a time offset (e.g., configured for each configured CSI). The WTRU 102 may receive the configuration information by RRC and/or MAC signaling.

In certain representative embodiments, an earliest occasion of a set of CSI reference resources may be determined based on any of the following: a trigger time for the activation of CSI computation of the configured CSI; a configured or pre-defined time offset; and/or the earliest time after at least N occasions of each CSI measurement resource for channel and interference of the configured CSI (e.g., following activation of CSI computation for the configured CSI). For example, a value of N may be pre-defined or configured.

In certain representative embodiments, a trigger time may include an end of a last symbol of a transmission containing signaling triggering the CSI computation, or be a time when a trigger condition is satisfied.

### CSI Reporting

### Triggers for Initiating Reporting

In certain representative embodiments, a WTRU 102 may determine whether one or more trigger conditions have occurred for initiating CSI reporting.

In certain representative embodiments, a WTRU 102 may initiate CSI reporting of at least one CSI instance of a CSI configuration when at least one trigger condition occurs. For example, a trigger condition may be active only under a condition that CSI calculation has been activated for the corresponding CSI configuration. A trigger condition for initiating CSI reporting may include any one of, or a combination of, at least one of following events.

In some embodiments, a WTRU 102 may receive signaling indicating initiation or activation of CSI reporting for at least one configured CSI. For example, a WTRU 102 may report CSI instances for the at least one indicated configured CSI. As an example, the indication may be received from a PDCCH transmission, such as via DCI or in a MAC CE. For example, a value of a field (e.g., of DCI) and/or a trigger state indicated by a field (e.g., of DCI) may indicate whether the signaling is for initiating CSI reporting. As an example, the indication may be received from a RA response or from other DCI. As an example, the indication of a configured CSI may be by an index, such as to an identity of a measurement resource associated with the configured CSI or to an identity of a candidate TCI state associated to the configured CSI. As an example, the indication of a configured CSI may be by a trigger state or by a field (e.g., of DCI) indicating a trigger state. For example, the trigger state may be configured with a reference to another trigger state that includes the configured CSI.

In some embodiments, a WTRU 102 may receive signaling indicating a handover or a LTM cell switch, or the WTRU 102 determines a condition triggering a handover or a LTM cell switch (e.g., to a target cell). For example, a WTRU 102 may report CSI instance(s) of a CSI configuration associated to a target cell and/or a TCI state indicated in the handover or cell switch command (e.g., where CSI calculation is activated for at least one such CSI configuration). For example, a WTRU 102 may report CSI instance(s) of at least one CSI configuration associated to other cells if indicated in the cell switch command, or if at least one condition is satisfied for the CSI configuration (e.g., CSI quantity above a threshold). For example, the signaling may indicate whether to report for the target cell, other cells, or both.

In some embodiments, a WTRU 102 may switch to a different BWP (e.g., from a first BWP to a second BWP). For example, a WTRU 102 may report CSI instance(s) for at least one configured CSI associated with the BWP.

In some embodiments, a WTRU 102 may activate a serving cell and/or carrier. For example, a WTRU 102 may report CSI instance(s) for at least one configured CSI associated with the serving cell and/or carrier.

In some embodiments, a WTRU 102 may detect a signal, such as a LP-WUS. For example, a WTRU 102 may report CSI instance(s) for at least one configured CSI associated with the signal.

In some embodiments, a WTRU 102 may determine that data becomes available for transmission for a logical channel and/or data flow.

In some embodiments, a WTRU 102 may receive data for a logical channel and/or data flow. For example, a WTRU 102 may report CSI instance(s) for at least one configured CSI associated with the logical channel and/or data flow for which data is available and/or for which the WTRU 102 received data.

In some embodiments, a WTRU 102 may complete CSI calculation for a CSI instance for a CSI reference resource occasion. For example, the CSI reference resource occasion may be the first occasion after activation of the CSI calculation. For example, the CSI reference resource occasion may be a determined occasion, such as described herein.

In some embodiments, a WTRU 102 may determine that a condition is satisfied for a CSI instance, calculated for a CSI reference resource occasion, for a configured CSI. For example, this may be applicable to the latest CSI reference resource occasion for which results of CSI instance are available. For example, a condition may be that a CSI quantity is above, or below, a (e.g., configured) threshold, such as for at least one CSI quantity or threshold. For example, a condition may have multiple parts, such as that a CQI index is above a first threshold and a RI is above a second threshold. For example, a condition may be that a CSI quantity changes by more than a configured threshold (e.g., higher or lower) compared to a last reported CSI instance of the configured CSI, such as for at least one CSI quantity or threshold. For example, a condition may be that a difference between a CQI index of the CSI instance and a CQI index of the latest reported CSI instance for the configured CSI is larger (e.g., in absolute value) than a first threshold, and/or that a difference between a RI of the CSI instance and a RI of the latest reported CSI instance for the configured CSI is larger (e.g., in absolute value) than a second threshold. For example, a condition may be related to a measurement result, such as L1-RSRP, for a measurement resource associated with the CSI configuration. For example, a condition may be that a measurement result is above, or below, a threshold, and/or that the measurement result for a resource is an offset greater than measurement results for other resources (e.g., associated with the CSI configuration).

In some embodiments, a WTRU 102 may have uplink resources (e.g., PUSCH resources) and a number of padding bits is greater than a payload required for the transmission of results for a MAC CE containing at least one CSI instance. For example, a number of padding bits may be determined after inclusion of higher layer data and any MAC CE(s) of higher priority. Such a CSI report may be referred to as a “padding CSI” report.

In certain representative embodiments, a WTRU 102 may receive signaling (e.g., via RRC or MAC) for determining any of an association, threshold information, and/or offsets. For example, the association may be between a (e.g., at least one) configured CSI and any of: at least one TCI state, at least one candidate TCI state, at least one measurement resource, at least one cell, at least one BWP, a serving cell, at least one logical channel and/or at least one data flow. For example, the threshold information (e.g., thresholds) and/or offset information (e.g., offsets) may be applicable to any condition related to a CSI instance.

### Determination of Reported CSI Instance

In certain representative embodiments, a WTRU 102 may report results of a CSI instance of a CSI reference resource occasion determined for at least one configured CSI. For example, the WTRU 102 may determine the CSI reference resource occasion as described herein.

### CSI Reference Resource Occasion

In certain representative embodiments, a WTRU 102 may determine a CSI reference resource occasion as any of the following: a last occasion for which CSI results are available at a (e.g., specific) reference time; a last occasion occurring before a (e.g., specific) reference time; and/or a first occasion occurring after a (e.g., specific) reference time.

In certain representative embodiments, the reference time may be a function of at least one of the following.

In some embodiments, the reference time may be a time related to a trigger for the activation of CSI calculation for at least one configured CSI. For example, the end of a last symbol of a PDCCH transmission carrying signaling requesting activation of CSI calculation and/or containing a cell switch command. For example, the end of a last symbol of an uplink transmission containing L1 measurement reports or another indication, such that CSI calculation is activated for the configured CSI. For example, the time of the start or end of a PDSCH transmission carrying downlink data for a logical channel and/or a data flow, or of a PDCCH transmission scheduling this PDSCH.

In some embodiments, the reference time may be a time related to a trigger for the reporting of a CSI instance for at least one configured CSI. For example, the end of a last symbol of a PDCCH transmission carrying signaling requesting reporting of a CSI instance or containing a cell switch command.

In some embodiments, the reference time may be a time related to an uplink resource in which the CSI instance is to be reported, or related to signaling scheduling this uplink resource. For example, the start of the first symbol of a physical channel (e.g., PUCCH or PUSCH) transmission, such as where CSI is transmitted as uplink control information or in which CSI is transmitted in a MAC CE. For example, the end of a last symbol of a downlink channel (e.g., PDCCH) transmission carrying signaling for the uplink resource.

In some embodiments, the reference time may be a time related to a procedure triggering the activation of CSI calculation and/or reporting of CSI instance. For example, the start time of a first uplink (e.g., PUSCH) transmission after a handover or a cell switch. For example, the start time of a specific uplink transmission following a cell switch (e.g., msg3, msg5, transmission containing a configuration complete message). For example, the last symbol of a downlink (e.g., PDCCH) transmission carrying signaling for a cell switch command, a BWP switc,h or a serving cell activation. For example, the start time of a first uplink (e.g., SR via PUCCH, or PUSCH) transmission after data becomes available for a logical channel and/or data flow associated to the configured CSI;

In some embodiments, the reference time may be based on (e.g., a function of) a configured or pre-defined time offset. For example, the reference time may be a time related to one of the above triggers or procedures modified by (e.g., minus) the time offset. For example, the time offset may be a function of the required CSI computation time for the CSI instance.

### Determination of Uplink Resource

In certain representative embodiments, the CSI result(s) of at least one CSI instance may be encoded as uplink control information (e.g., via PUCCH or PUSCH transmission) or inside a MAC CE.

In certain representative embodiments, a WTRU 102 may determine an uplink resource in which CSI results for the at least one CSI instance based on any of the following.

In some embodiments, a WTRU 102 may determine an uplink resource (e.g., PUSCH or PUCCH) indicated in the signaling triggering CSI reporting. For example, a PUSCH or PUCCH resource indicated in DCI. For example, a resource indicated in cell switch command.

In some embodiments, a WTRU 102 may determine a specific uplink resource associated with a procedure triggering the activation of CSI calculation and/or reporting. For example, a first PUSCH transmission after a handover or a cell switch. For example, a transmission in response to a RA response (e.g., msg3). For example, a transmission containing configuration complete message. For example, a (e.g., first) transmission after successful contention resolution.

In some embodiments, a WTRU 102 may determine a first available suitable uplink resource, such as where the suitable uplink resource may satisfy at least one of following conditions: an available payload of UCI or MAC CE is greater than a payload of CSI results; a type of grant (e.g., dynamic or configured grant) is one of an allowed type(s) of grants; and/or an uplink channel (e.g., PUCCH or PUSCH) property such as a serving cell, a sub-carrier spacing, a duration, and/or a priority index is one of an allowed value(s) for the property.

In certain representative embodiments, a WTRU 102 may initiate transmission and retransmissions on a resource, such as PUCCH (e.g., a scheduling or UCI request), until a suitable uplink resource becomes available. The resource may be configured for the configured CSI.

In certain representative embodiments, a WTRU 102 may indicate in an uplink resource that results are available for a CSI configuration, such as where such uplink resource is not suitable (e.g., to transmit the CSI results). For example, the WTRU 102 may provide the results of a CSI configuration in a first transmission after a cell switch if an available payload is sufficient to include the results. Otherwise, for example, the WTRU 102 may indicate in this transmission that results for a CSI configuration are available.

### Determination of Report Contents

In certain representative embodiments, a WTRU 102 may include any of following in a report, for at least one CSI configuration. For example, the WTRU 102 may include an identity associated with the CSI configuration. For example, the WTRU 102 may include an identity of a cell, a TCI state, and/or measurement resource associated with the CSI configuration. For example, the WTRU 102 may include whether results are available for a CSI instance of the CSI configuration. As an example, the WTRU 102 may indicate an “out-of-range” value for at least one CSI quantity if results are not available. For example, the WTRU 102 may include (e.g., for each CSI instance) results for CSI quantities as per the CSI configuration, if available. For example, the WTRU 102 may include (e.g., for each CSI instance) an indication of the applicable reference resource occasion. For example, the WTRU 102 may include an indication of a reference resource occasion for which results of a CSI instance are available or will be available. For example, the WTRU 102 may include an indication of the time when results of a CSI instance will be available. The time may be relative to the indication or relative to another reference time.

In some embodiments, an indication of a reference resource occasion may be a time index or an occasion index. The time or occasion index may be absolute, or relative to a reference time, such as those described above.

### Determination of Priority

In certain representative embodiments, a WTRU 102 may determine a priority level for a CSI configuration, or a CSI instance of a CSI configuration. The WTRU 102 may use the priority level for any of the following: CSI computation prioritization (e.g., when multiple CSI instances are calculated in parallel and an available number of processing units is limited); CSI reporting prioritization (e.g., when results of multiple CSI instances are transmitted in a same report and an available payload is limited); and/or logical channel prioritization (e.g., when results for CSI instances are included in a MAC CE and other MAC CE's can be multiplexed in a transport block or a PUSCH transmission).

In certain representative embodiments, a WTRU 102 may determine a priority level or index for a CSI instance based on any of the following: an explicit configuration (e.g., as part of the corresponding CSI configuration); a type of CSI quantity (e.g., measured during the CSI instance); a trigger for activating CSI measurement or for CSI reporting (e.g., of the CSI instance); and/or whether a MAC CE is included as padding CSI or is included because of another report trigger.

For example, a priority level may be associated with a type of trigger. For example, a CSI instance related to a trigger related to a cell switch command or cell switch initiation may have a higher priority than CSI instances triggered by other events, or than CSI triggered by legacy solutions. For example, a priority level may be explicitly indicated in the signaling triggering the activation of a CSI measurement or the reporting of a CSI instance.

For example, a MAC CE may be included as padding CSI or is included because of another report trigger. For example, a WTRU 102 may receive a configuration of a first (e.g. lower) priority level applicable when CSI is included in a MAC CE as padding CSI and a second (e.g. higher) priority level applicable when CSI is included in a MAC CE due to any other report trigger.

### Co-Existence With Legacy CSI Procedures

In certain representative embodiments, a WTRU 102 may (e.g., in addition to using procedures described herein) be configured to report (e.g., certain or some) CSI configurations according to legacy procedures, such as where a (e.g., single) DCI or MAC CE activates CSI measurement and computation and indicates resources for reporting.

In certain representative embodiments, a CSI configuration (e.g., a field thereof) may indicate to a WTRU 102 a mode of operation for triggering and reporting CSI. For example, at least one mode of operation may correspond to legacy procedures. For example, at least one mode of operation may correspond to a combination of the procedures described herein. As an example, a first indication may be used to activate, or deactivate, CSI computation and a second indication may be used to activate, or deactivate, CSI reporting.

In certain representative embodiments, a field (e.g., of DCI) or a trigger state (e.g., indicated by DCI) may indicate whether the signaling is to activate CSI computation only (e.g., with no indication of reporting), to both activate CSI computation and trigger CSI reporting (e.g. as in legacy procedures), or to only trigger CSI reporting. For example, a first trigger state may include configurations indicating a set of CSI resource sets and an indication that reporting is triggered separately (e.g., later). For example, a second trigger state may indicate that the signaling is for reporting CSI results corresponding to another indicated trigger state (e.g., the first trigger state).

### Example Procedures

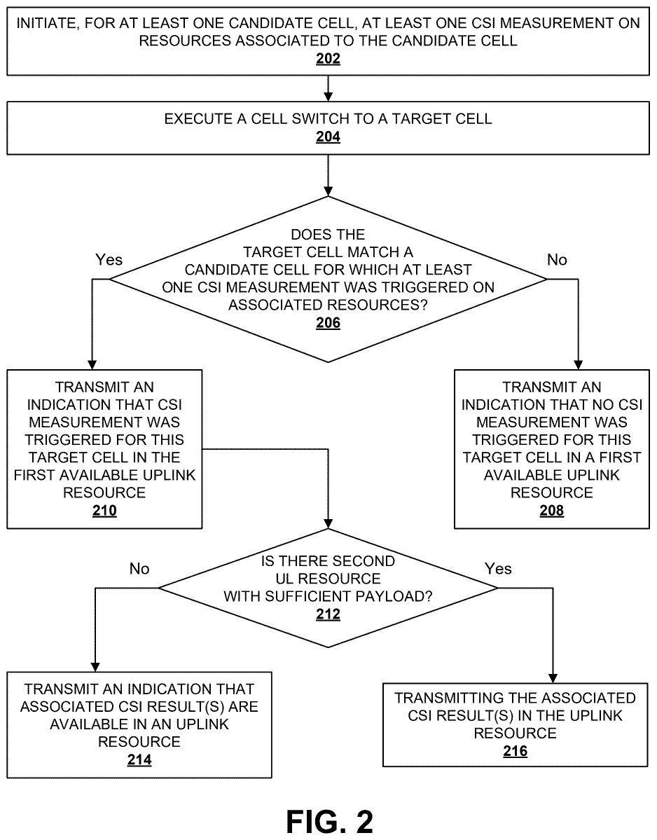

FIG. 2 is a flowchart diagram illustrating an example flow for asynchronous reporting of CSI, according to one or more embodiments of the present disclosure. As shown in FIG. 2, a WTRU 102 may initiate, for at least one candidate cell, at least one CSI measurement on resources associated to the candidate cell at 202. At 204, the WTRU 102 may execute a cell switch (or handover) to a target cell. At 206, the WTRU 102 may determine whether or not the target cell matches a candidate cell for which at least one CSI measurement was triggered on associated resources. If the target cell does not match one of the candidate cells at 206, the WTRU 102 may transmit an indication no CSI measurement was triggered for this target cell in a first available uplink resource at 208.

If the target cell does match one of the candidate cells at 206, the WTRU 102 may transmit an indication that CSI measurement was triggered for this target cell in the first available uplink resource at 210. At 212, after the WTRU 102 completes CSI computation for one (or all) CSI measurements triggered for one or more of the candidate cells (e.g., at least the target cell), the WTRU 102 may determine whether there is a second (e.g., available) uplink resource with a sufficient payload to carry one (or all) of the CSI measurements. If there is not a second uplink resource with a sufficient payload at 212, the WTRU 102 may transmit an indication that associated CSI result(s) are available in another uplink resource at 214. Otherwise, if there is a second uplink resource with a sufficient payload at 212, the WTRU 102 may transmit the associated CSI result(s) in the second uplink resource at 216. For example, the determination at 212 may occur based on one or more trigger conditions as described herein. For example, the uplink resource at 214 and/or 216 may be determined as described herein (e.g., via MAC CE, a PUCCH resource, a PUSCH resource).

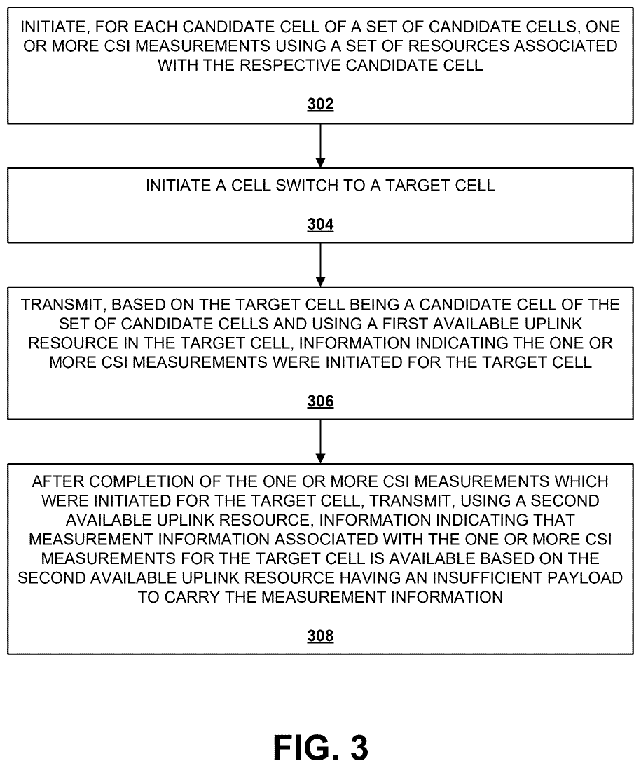

FIG. 3 is a procedural diagram illustrating an example procedure to indicate that CSI measurements are available for a target cell, according to one or more embodiments of the present disclosure. As shown in FIG. 3, a WTRU 102 may initiate, for each candidate cell of a set of candidate cells, one or more CSI measurements using a set of resources associated with the respective candidate cell at 302. At 304, the WTRU 102 may initiate a cell switch to a target cell. At 306, the WTRU 102 may transmit, based on (e.g., determining that) the target cell being (e.g., is) a candidate cell of the set of candidate cells and using a first available uplink resource in the target cell, information indicating the one or more CSI measurements were initiated for the target cell. At 308, after completion of the one or more CSI measurements which were initiated for the target cell, the WTRU 102 may transmit, using a second available uplink resource, information indicating that measurement information associated with the one or more CSI measurements for the target cell is available based on the second available uplink resource having an insufficient payload to carry the measurement information at 308.

For example, the WTRU 102 may initiate, for each candidate cell of the set of candidate cells, the one or more CSI measurements based on one or more triggering conditions.

For example, the WTRU 102 may complete the one or more CSI measurements which were initiated for the target cell after initiating the cell switch to the target cell. For example, each of the one or more CSI measurements may be performed using a (e.g., respective) CSI reference resource occasion.

For example, the WTRU 102 may determine whether or not the second available uplink resource has a sufficient payload to carry the measurement information.

For example, the information indicating the one or more CSI measurements were initiated for the target cell may be transmitted in a payload of a message of a random access procedure.

For example, the WTRU 102 may determine to stop (e.g., stop), for at least one candidate cell of the set of candidate cells, the one or more CSI measurements based on one or more triggering conditions.

For example, the WTRU 102 may transmit, based on the target cell being the candidate cell of the set of candidate cells and using the first available uplink resource in the target cell, information indicating whether or not the measurement information associated with the one or more CSI measurements for the target cell is available.

For example, the WTRU 102 may transmit, based on the target cell being the candidate cell of the set of candidate cells and using the first available uplink resource in the target cell, information indicating a time at which the measurement information associated with the one or more CSI measurements for the target cell will be available.

For example, the WTRU 102 may transmit, based on the target cell being the candidate cell of the set of candidate cells and using the first available uplink resource in the target cell, information indicating an identifier and/or resources associated with the one or more CSI measurements for the target cell.

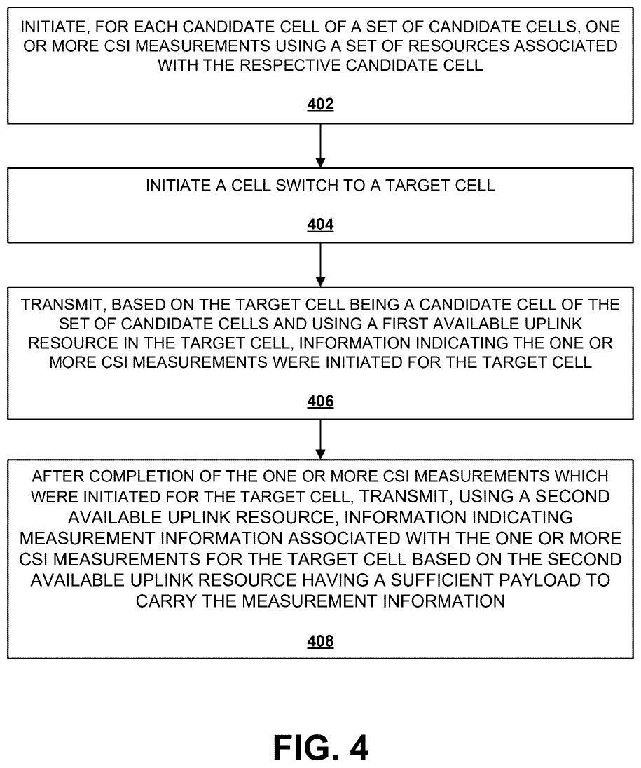

FIG. 4 is a procedural diagram illustrating an example procedure to transmit CSI measurements available for a target cell, according to one or more embodiments of the present disclosure. As shown in FIG. 4, a WTRU 102 may initiate, for each candidate cell of a set of candidate cells, one or more CSI measurements using a set of resources associated with the respective candidate cell at 402. At 404, the WTRU 102 may initiate a cell switch to a target cell. At 406, the WTRU 102 may transmit, based on (e.g., determining that) the target cell being (e.g., is) a candidate cell of the set of candidate cells and using a first available uplink resource in the target cell, information indicating the one or more CSI measurements were initiated for the target cell. At 408, after completion of the one or more CSI measurements which were initiated for the target cell, the WTRU 102 may transmit, using a second available uplink resource, information indicating measurement information associated with the one or more CSI measurements for the target cell based on the second available uplink resource having a sufficient payload to carry the measurement information at 408.

For example, the WTRU 102 may initiate, for each candidate cell of the set of candidate cells, the one or more CSI measurements based on one or more triggering conditions.

For example, the WTRU 102 may complete the one or more CSI measurements which were initiated for the target cell after initiating the cell switch to the target cell. For example, each of the one or more CSI measurements may be performed using a (e.g., respective) CSI reference resource occasion.

For example, the WTRU 102 may determine whether or not the second available uplink resource has a sufficient payload to carry the measurement information.

For example, the information indicating the one or more CSI measurements were initiated for the target cell may be transmitted in a payload of a message of a random access procedure.

For example, the WTRU 102 may determine to stop (e.g., stop), for at least one candidate cell of the set of candidate cells, the one or more CSI measurements based on one or more triggering conditions.

For example, the WTRU 102 may transmit, based on the target cell being the candidate cell of the set of candidate cells and using the first available uplink resource in the target cell, information indicating whether or not the measurement information associated with the one or more CSI measurements for the target cell is available.

For example, the WTRU 102 may transmit, based on the target cell being the candidate cell of the set of candidate cells and using the first available uplink resource in the target cell, information indicating a time at which the measurement information associated with the one or more CSI measurements for the target cell will be available.

For example, the WTRU 102 may transmit, based on the target cell being the candidate cell of the set of candidate cells and using the first available uplink resource in the target cell, information indicating an identifier and/or resources associated with the one or more CSI measurements for the target cell.

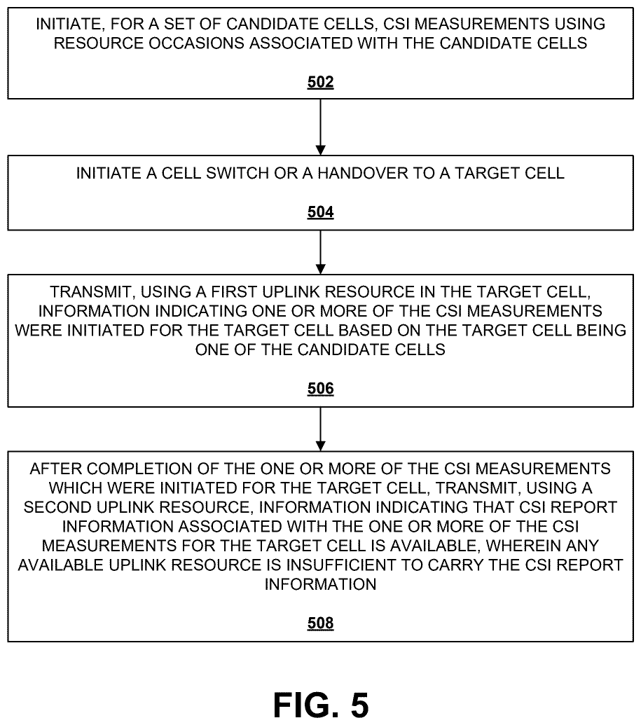

FIG. 5 is a procedural diagram illustrating an example procedure to indicate that CSI reporting information is available for a target cell, according to one or more embodiments of the present disclosure. As shown in FIG. 5, a WTRU 102 may initiate, for a set of candidate cells, CSI measurements using resource occasions associated with the candidate cells at 502. At 504, the WTRU 102 may initiate a cell switch or a handover to a target cell. At 506, the WTRU 102 may transmit, using a first uplink resource in the target cell, information indicating one or more of the CSI measurements were initiated for the target cell based on the target cell being one of the candidate cells. At 508, the WTRU 102 may, after completion of the one or more of the CSI measurements which were initiated for the target cell, transmit, using a second uplink resource, information indicating that CSI report information associated with the one or more of the CSI measurements for the target cell is available. For example, the WTRU 102 may perform the transmission using the second uplink resource when it is determined that any available uplink resource is insufficient to carry the CSI report information.

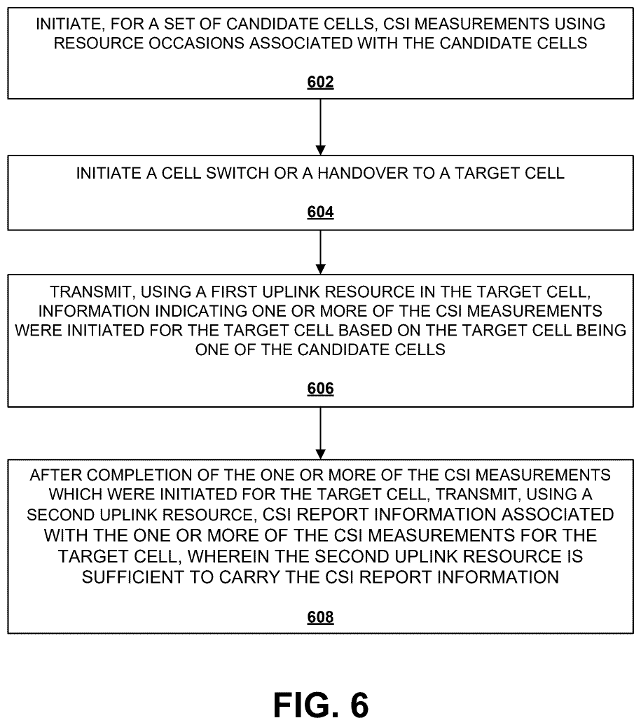

FIG. 6 is a procedural diagram illustrating an example procedure to transmit CSI reporting information available for a target cell, according to one or more embodiments of the present disclosure. As shown in FIG. 6, a WTRU 102 may initiate, for a set of candidate cells, CSI measurements using resource occasions associated with the candidate cells at 602. At 604, the WTRU 102 may initiate a cell switch or a handover to a target cell. At 606, the WTRU 102 may transmit, using a first uplink resource in the target cell, information indicating one or more of the CSI measurements were initiated for the target cell based on the target cell being one of the candidate cells. At 608, the WTRU 102 may, after completion of the one or more of the CSI measurements which were initiated for the target cell, transmit, using a second uplink resource, CSI report information associated with the one or more of the CSI measurements for the target cell. For example, the WTRU 102 may perform the transmission using the second uplink resource when it is determined that the second uplink resource is sufficient to carry the CSI report information.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1. A wireless transmit/receive unit (WTRU) comprising:
a processor, memory, and a transceiver which are configured to:
initiate, for each candidate cell of a set of candidate cells, one or more channel state information (CSI) measurements using a set of resources associated with the respective candidate cell,
initiate a cell switch to a target cell,
transmit, based on the target cell being a candidate cell of the set of candidate cells and using a first available uplink resource in the target cell, information indicating the one or more CSI measurements were initiated for the target cell, and
after completion of the one or more CSI measurements which were initiated for the target cell, transmit, using a second available uplink resource, information indicating that measurement information associated with the one or more CSI measurements for the target cell is available based on the second available uplink resource having an insufficient payload to carry the measurement information.

2. A wireless transmit/receive unit (WTRU) comprising:
a processor, memory, and a transceiver which are configured to:
initiate, for each candidate cell of a set of candidate cells, one or more channel state information (CSI) measurements using a set of resources associated with the respective candidate cell,
initiate a cell switch to a target cell,
transmit, based on the target cell being a candidate cell of the set of candidate cells and using a first available uplink resource in the target cell, information indicating the one or more CSI measurements were initiated for the target cell, and
after completion of the one or more CSI measurements which were initiated for the target cell, transmit, using a second available uplink resource, information indicating measurement information associated with the one or more CSI measurements for the target cell based on the second available uplink resource having a sufficient payload to carry the measurement information.

3. The WTRU of claim 2, wherein the processor, memory, and the transceiver are configured to initiate, for each candidate cell of the set of candidate cells, the one or more CSI measurements based on one or more triggering conditions.

4. The WTRU of claim 2, wherein the processor, memory, and the transceiver are configured to complete the one or more CSI measurements which were initiated for the target cell after initiating the cell switch to the target cell, and
wherein each of the one or more CSI measurements are performed using a CSI reference resource occasion.

5. The WTRU of claim 2, wherein the processor, memory, and the transceiver are configured to determine whether or not the second available uplink resource has a sufficient payload to carry the measurement information.

6. The WTRU of claim 2, wherein the information indicating the one or more CSI measurements were initiated for the target cell is transmitted in a payload of a message of a random access procedure.

7. The WTRU of claim 2, wherein the processor, memory, and the transceiver are configured to determine to stop, for at least one candidate cell of the set of candidate cells, the one or more CSI measurements based on one or more triggering conditions.

8. The WTRU of claim 2, wherein the processor, memory, and the transceiver are configured to transmit, based on the target cell being the candidate cell of the set of candidate cells and using the first available uplink resource in the target cell, information indicating whether or not the measurement information associated with the one or more CSI measurements for the target cell is available.

9. The WTRU of claim 2, wherein the processor, memory, and the transceiver are configured to transmit, based on the target cell being the candidate cell of the set of candidate cells and using the first available uplink resource in the target cell, information indicating a time at which the measurement information associated with the one or more CSI measurements for the target cell will be available.

10. The WTRU of claim 2, wherein the processor, memory, and the transceiver are configured to transmit, based on the target cell being the candidate cell of the set of candidate cells and using the first available uplink resource in the target cell, information indicating an identifier and/or resources associated with the one or more CSI measurements for the target cell.

11. (canceled)

12. A method implemented by a wireless transmit/receive unit (WTRU), the method comprising:
initiating, for each candidate cell of a set of candidate cells, one or more channel state information (CSI) measurements using a set of resources associated with the respective candidate cell;
initiating a cell switch to a target cell;
transmitting, based on the target cell being a candidate cell of the set of candidate cells and using a first available uplink resource in the target cell, information indicating the one or more CSI measurements were initiated for the target cell; and
after completion of the one or more CSI measurements which were initiated for the target cell, transmitting, using a second available uplink resource, information indicating measurement information associated with the one or more CSI measurements for the target cell based on the second available uplink resource having a sufficient payload to carry the measurement information.

13. The method of claim 12, wherein the one or more CSI measurements are initiated, for each candidate cell of the set of candidate cells, based on one or more triggering conditions.

14. The method of claim 12, wherein the one or more CSI measurements which were initiated for the target cell are completed after initiating the cell switch to the target cell, and
wherein each of the one or more CSI measurements are performed using a CSI reference resource occasion.

15. The method of claim 12, further comprising:
determining whether or not the second available uplink resource has a sufficient payload to carry the measurement information.

16. The method of claim 12, wherein the information indicating the one or more CSI measurements were initiated for the target cell is transmitted in a payload of a message of a random access procedure.

17. The method of claim 12, wherein the one or more CSI measurements are stopped for at least one candidate cell of the set of candidate cells based on one or more triggering conditions.

18. The method of claim 12, further comprising:
transmitting, based on the target cell being the candidate cell of the set of candidate cells and using the first available uplink resource in the target cell, information indicating whether or not the measurement information associated with the one or more CSI measurements for the target cell is available.

19. The method of claim 12, further comprising:
transmitting, based on the target cell being the candidate cell of the set of candidate cells and using the first available uplink resource in the target cell, information indicating a time at which the measurement information associated with the one or more CSI measurements for the target cell will be available.

20. The method of claim 12, further comprising:
transmitting, based on the target cell being the candidate cell of the set of candidate cells and using the first available uplink resource in the target cell, information indicating an identifier and/or resources associated with the one or more CSI measurements for the target cell.
